(19) United States
(12) Patent Application Publication
(10) Pub. No.: US 2013/0280146 A1
(43) Pub. Date: Oct. 24, 2013

(54) SYSTEMS AND METHODS FOR SEPARATION AND ANALYSIS OF TARGET ANALYTES

(71) Applicant: RARECYTE, INC., Seattle, WA (US)

(72) Inventors: Ronald C. Seubert, Sammamish, WA (US); Jonathan E. Lundt, Seattle, WA (US); Joshua J. Nordberg, Bainbridge Island, WA (US)

(73) Assignee: RareCyte, Inc., Seattle, WA (US)

(21) Appl. No.: 13/850,176

(22) Filed: Mar. 25, 2013

Related U.S. Application Data
(60) Provisional application No. 61/625,863, filed on Apr. 18, 2012.

(51) Int. Cl. B04B 7/08

(52) U.S. Cl. CPC B04B 7/08
USPC 422/533

(57) ABSTRACT

Systems for analyzing multiple target analytes of a suspension include a tube and multiple floats. The target analytes are conjugated with at least one fluorescent marker, and the tube, multiple floats and suspension are centrifuged so that at least a portion of each target analyte is located between the inner wall of the tube and the surface of the respective float. In order to identify each target analyte, the portions of the suspension between the tube and each float is illuminated with one or more channels of excitation light, which causes the at least one fluorescent marker to become excited and emit light at longer wavelengths. One of the target analytes may be used to assess quality control or may aid in a subsequent analysis or diagnosis.

### CROSS-REFERENCE TO A RELATED APPLICATION

This application claims the benefit of Provisional Application No. 61/625,863; filed Apr. 18, 2012 which is incorporated by reference in its entirety.

### TECHNICAL FIELD

This disclosure relates generally to density-based fluid separation and, in particular, to tube and multiple floats systems for the separation and axial expansion of constituent suspension components layered by centrifugation.

### BACKGROUND

Suspensions often include materials of interest that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as ova, fetal cells, endothelial cells, parasites, bacteria, and inflammatory cells, and viruses, including HIV, cytomegalovirus, hepatitis C virus, and Epstein-Barr virus. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest composed of particles that occur in very low numbers are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers, but CTCs occur in very low numbers in peripheral whole blood samples. For instance, a 7.5 ml sample of peripheral whole blood that contains as few as 5 CTCs is considered clinically relevant in the diagnosis and treatment of a cancer patient. However, detecting even 1 CTC in a 7.5 ml blood sample is equivalent to detecting 1 CTC in a background of about 50 billion red and white blood cells. Using existing techniques to find, isolate and extract as few as 3 CTCs of a whole blood sample is extremely time consuming, costly and may be impossible to accomplish.

As a result, practitioners, researchers, and those working with suspensions continue to seek systems and methods to more efficiently and accurately detect, isolate and extract target materials of a suspension.

### DESCRIPTION OF THE DRAWINGS

FIGS. 1A-1D show isometric views of example tube and multiple floats systems.

FIGS. 2A-2C show example floats.

FIGS. 3-6 show example floats.

FIGS. 7A-7B show example floats.

FIG. 8A shows an isometric view of a tube and multiple floats system.

FIG. 8B shows an isometric view of a tube and multiple floats system.

FIG. 9A shows an isometric view of a tube and multiple floats system.

FIG. 9B shows an isometric view of a tube and multiple floats system.

FIG. 10 shows isometric and magnified views of an imaging process.

### DETAILED DESCRIPTION

This disclosure is directed to systems and methods for analyzing multiple target analytes of a suspension. The system includes a tube and multiple floats. Each float has a different density and no two floats have the same density, such that each float traps a different target analyte within the suspension. In one aspect, the floats include complementary mating features to allow for mating or trapping of material between consecutive floats. In another aspect, the floats do not include the complementary mating features. One of the target analytes may be used to assess quality control or may aid in a subsequent analysis or diagnosis.

The detailed description is organized into two subsections: 1) a general description of tube and multiple floats systems is provided in a first subsection; and 2) methods for using tube and multiple float systems to analyze target analytes of a suspension.

It should be understood that “fraction” may refer to a visually- or physically-delineated component of a suspension after undergoing density-based separation, such as by centrifugation. A visual delineation is one in which the actual separation can be seen by the naked eye, whereas a physical separation is one in which components are separated, though the delineation may not be seen by the naked eye. A fraction, for example, may be small in number such that after centrifugation the fraction is physically separated from other fractions by density, though the separation and delineation is not seen by the naked eye.

General Description of Tube and Multiple Floats Systems

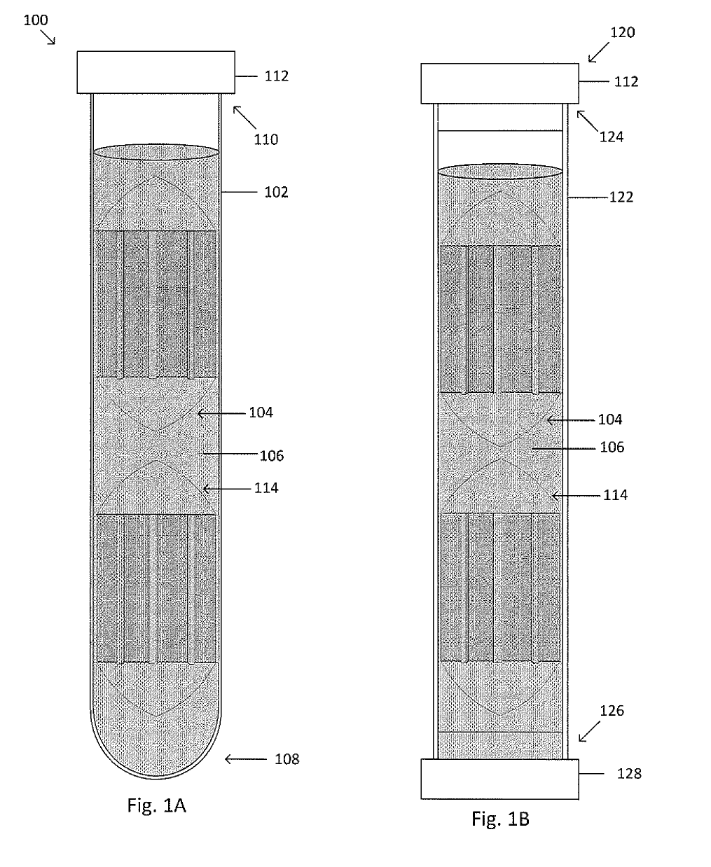

FIG. 1A shows an isometric view of an example tube and multiple floats system 100. The system 100 includes a tube 102 and multiple floats, including a first float 104 and a second float 114, suspended within a suspension 106. In the example of FIG. 1A, the tube 102 has a circular cross-section, a first closed end 108, and a second open end 110. The second float 114 may be denser than the first float 104. The open end 110 is sized to receive a stopper or cap 112. A tube may also have two open ends that are sized to receive stoppers or caps, such as the tube 122 of an example tube and multiple floats system 120 shown FIG. 1B. The system 120 is similar to the system 100 except the tube 100 of the system 102 is replaced by a tube 122 that includes two open ends 124 and 126 configured to receive the cap 112 and a cap 128, respectively. The tubes 102 and 122 have a generally cylindrical geometry, but may also have a tapered geometry that widens toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The tubes 102 and 122 can be composed of an opaque, translucent, transparent or semitransparent material. The tubes 102 and 122 may be composed of a flexible plastic or another suitable material.

A float may also have a concave end (top or bottom) which is complementary in nature to a protruding end cap (top or bottom) of another float to promote interaction of the two floats, whether by mating or trapping a target analyte or suspension material between the floats. FIG. 1C shows a system 130 including the tube and multiple floats 114 and 132. The system 130 is similar to the system 100 except that the float 104 of the system 100 is replaced by the float 132 that includes a concave bottom end. FIG. 1D shows a system 140 including the tube and multiple floats 104 and 142. The system 140 is similar to the system 100 except that the float 114 of the system 100 is replaced by a float 142 that includes a concave top end.

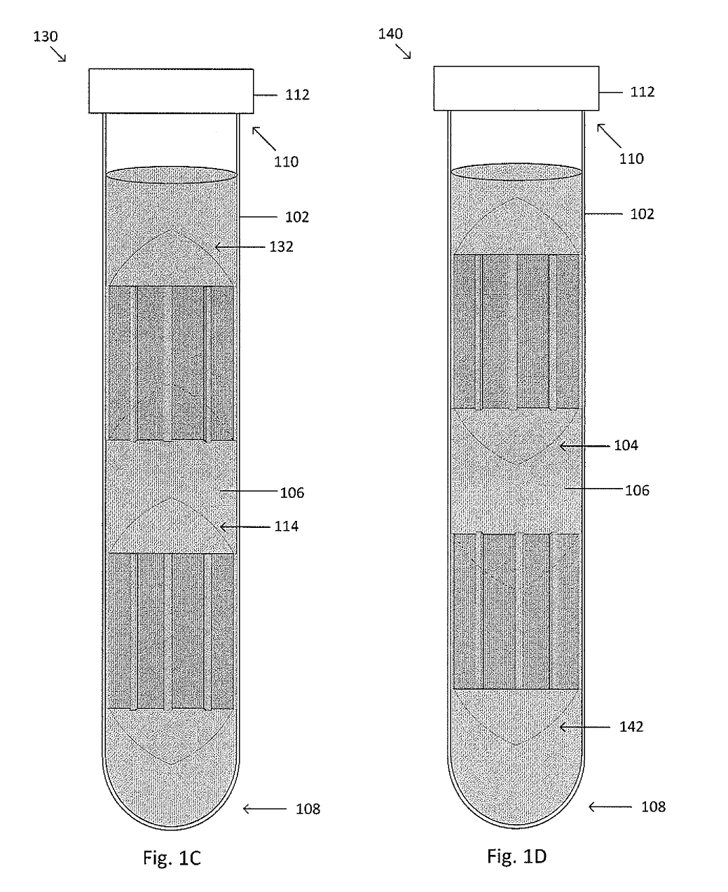

FIG. 2A shows an isometric view of the floats 104 and 114 shown in FIG. 1. The floats 104 and 114 include a main body 202, two teardrop-shaped end caps 204 and 206, and support members 208 radially spaced and axially oriented on the main body 202. A float can also include two dome-shaped end caps or two cone-shaped end caps. The support members 208 engage the inner wall of the tube 102. In alternative embodiments, the number of support members, support member spacing, and support member thickness can each be independently varied. The support members 208 can also be broken or segmented. The main body 202 is sized to have an outer diameter that is less than the inner diameter of the tube 102, thereby defining fluid retention channels between the outer surface of the body 202 and the inner wall of the tube 102. The surfaces of the main body 202 between the support members 208 can be flat, curved or have another suitable geometry. In the example of FIG. 2A, the support members 208 and the main body 202 form a single structure. Alternatively, a float 132 may have a concave bottom end 212, as shown in FIG. 2B, thereby being depressed into the main body 202 of the float 132. Alternatively, a float 142 may have a concave top end 222, as shown in FIG. 2C, thereby being depressed into the main body 202 of the float 142.

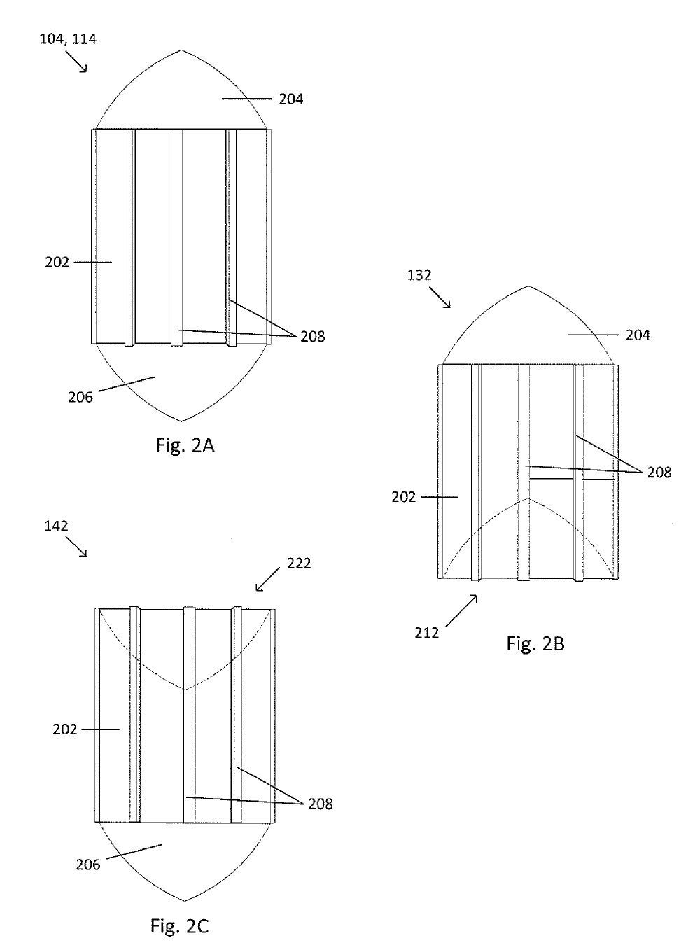

The concavity may be teardrop-shaped, conical, spherical, circular, tetrahedral, or any other appropriate shape. Alternatively, the outer diameter of the main body 202 may be sized to be equal to or greater than the inner diameter of the tube 102. Alternatively, the complementary end caps (i.e. the respective caps of respective floats configured to mate together) may be planar or substantially planar. The corners connecting the planar or substantially planar facets of the end caps to the sides of the end caps may be straight, curved, angled, or chamfered. Embodiments include other types of geometric shapes for float end caps. FIG. 3 shows an isometric view of an example float 300 with a dome-shaped end cap 302 and a cone-shaped end cap 304. The main body 306 of the float 300 can includes the same structural elements (i.e., support members) as the float 104. A float can also include a teardrop-shaped end cap. The float end caps can include other geometric shapes and are not intended to be limited the shapes described herein.

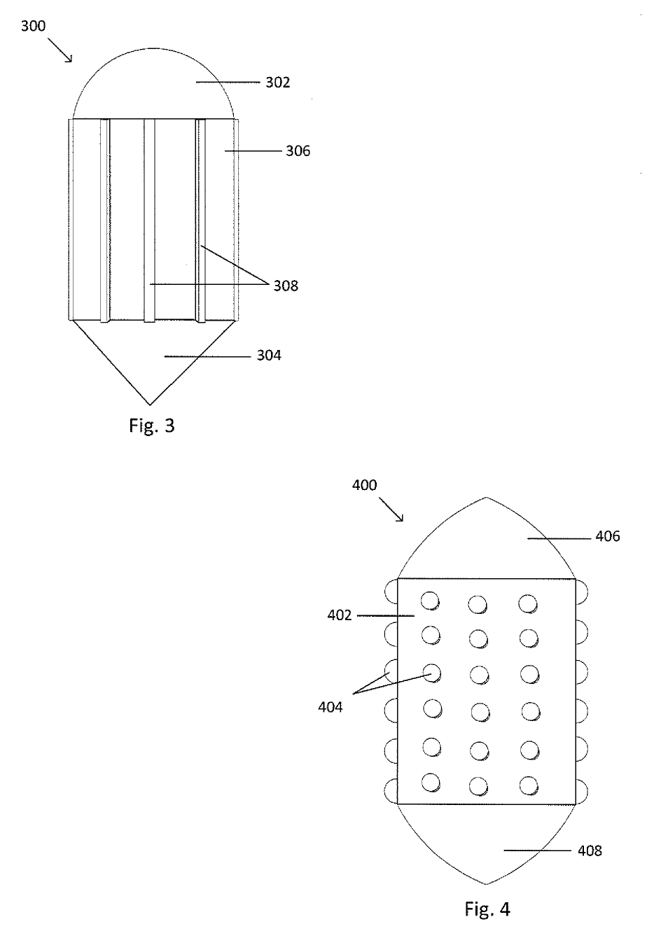

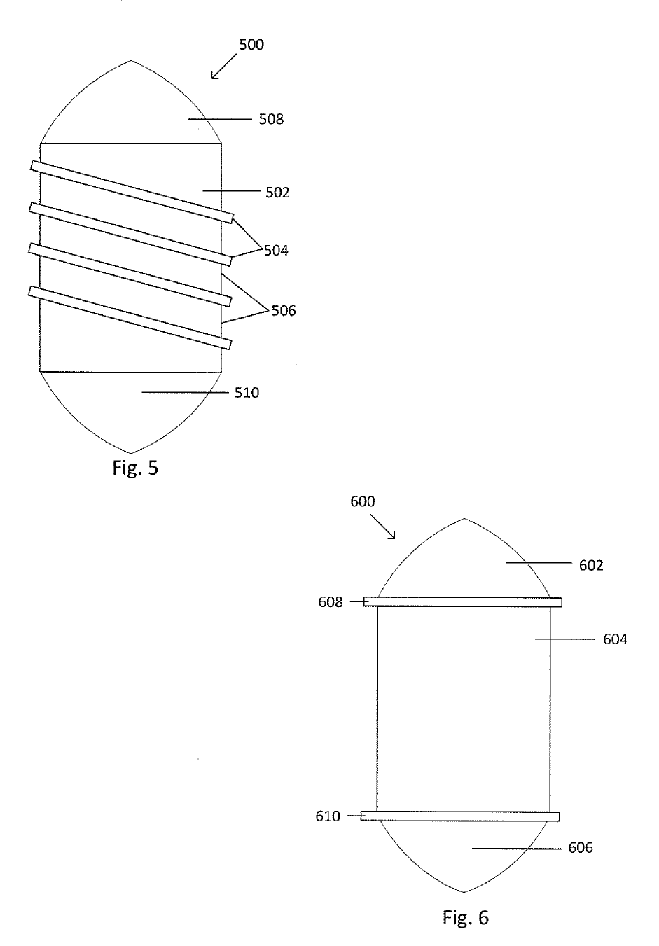

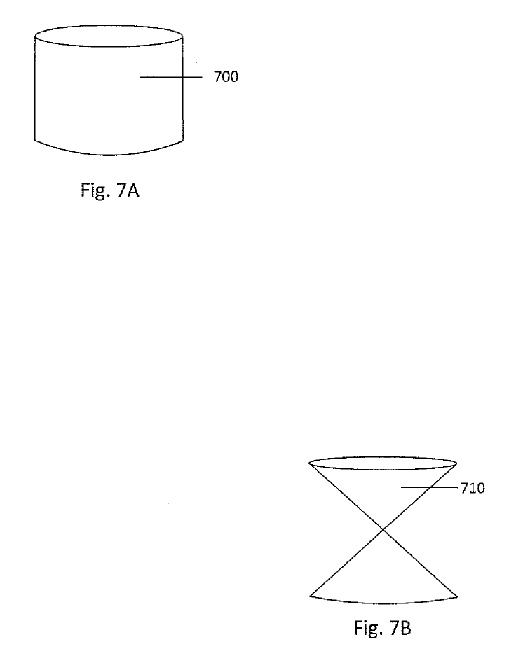

In other embodiments, the main body of the float 104 can include a variety of different support members for separating target materials, supporting the tube wall, or directing the suspension fluid around the float during centrifugation. FIGS. 4, 5, and 6 show examples of three different types of support members. Embodiments are not intended to be limited to these three examples. In FIG. 4, the main body 402 of a float 400 is similar to the float 104 except the main body 402 includes a number of protrusions 404 that provide support for the tube. In alternative embodiments, the number and pattern of protrusions can be varied. In FIG. 5, the main body 502 of a float 500 includes a single continuous helical structure or ridge 504 that spirals around the main body 502 creating a helical channel 506. In other embodiments, the helical ridge 504 can be rounded or broken or segmented to allow fluid to flow between adjacent turns of the helical ridge 504. In various embodiments, the helical ridge spacing and rib thickness can be independently varied. In FIG. 6, a main body 602 of a float 600 includes support members 608 and 610 extending circumferentially around the main body 702. One of the support members 608 and 610 can be omitted.

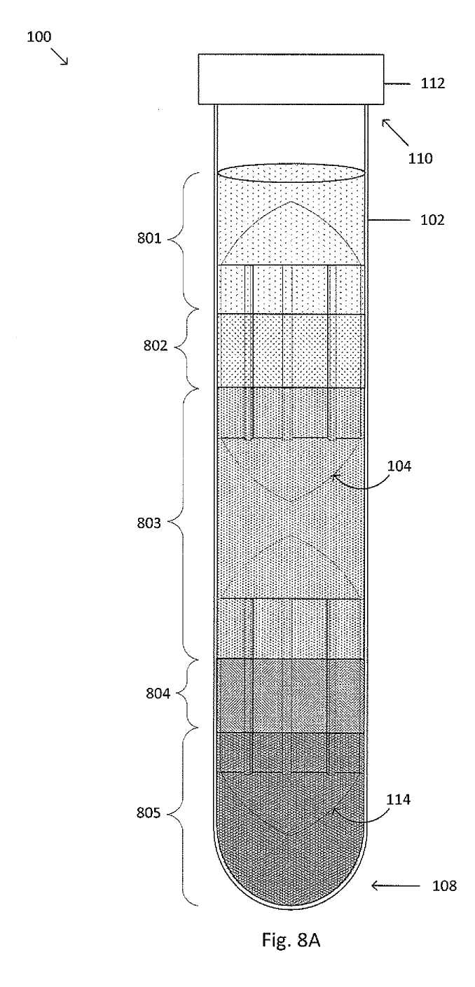

FIG. 7A shows an isometric of an example first float 700. The first float 700 is disc-shaped. The first float 700 may be located at or above the uppermost layer of the density-separated suspension, thereby creating a component-float-air interface. The first float 700 has a density that is less than or equal to the density of any fraction of the suspension. The first float 700 creates a component-float-air interface to decrease the surface area of the component-air interface, thereby reducing or eliminating the introduction of air into the suspension. FIG. 7B shows an isometric view of an example first float 710. The first float 710 is similar to the first float 700, except that the first float 710 is hourglass-shaped. The first floats 700 and 710 may or may not include support members.

Each of the multiple floats can be composed of a metal or metalloid; compressible materials, such as compressible polymers; organic or inorganic materials; plastic materials; and combinations thereof.

The support members may be included during the forming or machining processes or added after the forming and machining processes are complete.

The tube may have a sidewall and a first diameter, the sidewall being elastically radially expandable to a second diameter in response to an axial load, pressure due to centrifugation, an external vacuum, or internally-introduced pressure, the second diameter being sufficiently large to permit axial movement of the float in the tube during centrifugation.

The floats may move independently of each other. A consistent distance between floats may therefore not be maintained. Alternatively, the movement of the floats may dependent on each other, thereby maintaining a consistent difference. The consistent distance and/or trapping a target analyte or suspension material between the floats may occur mechanically—including, but not limited to, a shaft to link the floats and maintain distance—or magnetically—including magnets within the top and bottom end caps to repel or attract each other as desired.

### Methods

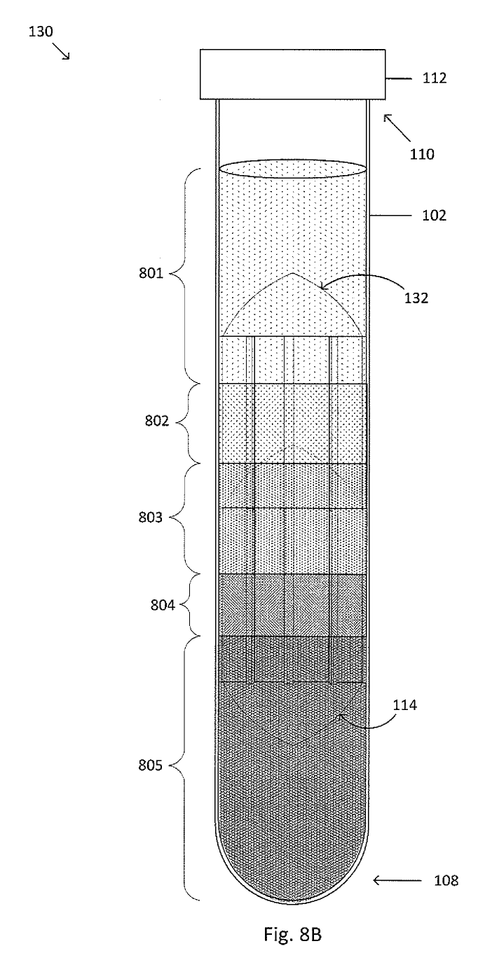

FIG. 8A shows a system 100 and a suspension that has undergone separation, such as centrifugation, thereby separating the suspension into density-based fractions. Suppose, for example, the suspension includes multiple fractions 801-805. During centrifugation, the suspension may be divided into and settle into the multiple fractions 801-805. A first target analyte may be found in one of the multiple fractions 802. A second target analyte may be found in another of the multiple fractions 804. The first float 104 may have a density substantially similar to that of the first target analyte, so that the first float 104 and the target analyte align properly within the tube 102. The second float 114, having a density greater than the density of the first float 104, may have a density substantially similar to that of the second target analyte, so that the second float 114 and the target analyte align properly within the tube 102.

The suspension, which is suspected of including the first target analyte and the second target analyte, is introduced into the tube 102. The first target analyte may be a lysed or fragmented portion of the second target analyte; or the first target analyte may be a different structure or composition than the second target analyte. When the first target analyte is a lysed or fragmented portion of the second target analyte, a solution containing a fluorescent marker may be used to label both the first and second target analytes. When the first and second target analytes are different or when the first target analyte is a lysed or fragmented portion of the second target analyte, a first solution containing a first fluorescent marker may be added to the tube 102 to label the first target analyte with the first fluorescent marker to provide a fluorescent signal for identification and characterization. A second solution containing a second fluorescent marker may be added to the tube 102 to label the second target analyte with the second fluorescent marker to provide a fluorescent signal for identification and characterization. The first and second target analytes of the suspension 106 may also be labeled prior to introduction into the tube 102. When the first and second target analytes have not been labeled prior to introduction to the tube 102, the contents of the tube 102 are mixed by shaking, swirling, rocking, inversion, rotating, vortex mixing, or stirring. The mixing may be done manually or with the aid of a machine, instrument, or the like. After mixing and conjugating, the first float 104 and the second float 114 are added to the tube 102. The system 100 is then centrifuged, thereby permitting separation of the suspension components into layers along an axial position in the tube 102 based on density. The first and second floats 104 and 114 are captured within the tube 102 at the same axial position as that of the first and second target analytes since the densities of the first and second floats 104 and 114 and first and second target analytes, respectively, are approximately the same. The first and second target analytes are trapped within an analysis area between the first and second floats 104 and 114 and the tube 102. The analysis area may then be imaged.

FIG. 8B shows an isometric view of a tube and multiple floats system 130 after undergoing density-based separation, such as by centrifugation. The system 130 includes a tube 102, a first float 132, and a second float 114. The first float 132 has a concave bottom as described in reference to FIGS. 1C and 2B. During and/or after centrifugation, the first and second floats 132 and 114 may mate. The concave bottom end 212 and the top cap 204 are complementary shapes, such that the concave bottom end 212 mates with the top cap 204 or trap a target analyte or suspension material between the concave bottom end 212 and the top cap 204. The first float 132 may trap a first target analyte located within fraction 802, while the second float 114 may trap a second target analyte located within fraction 804. Alternatively, a target analyte or suspension material may be trapped between the first and second floats 132 and 114. The component may or may not be a target analyte.

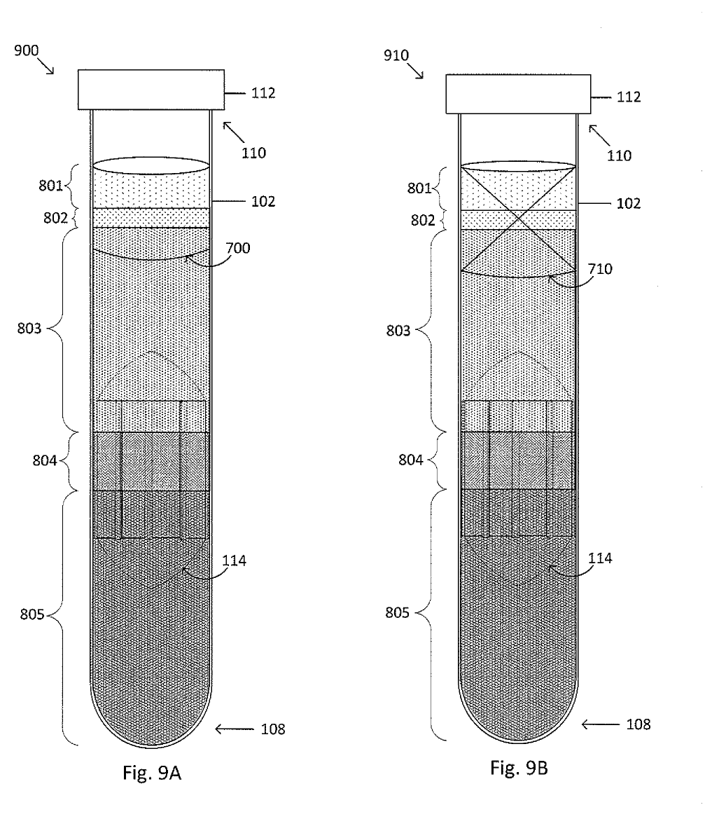

FIG. 9A shows an isometric view of a tube and multiple floats system 900 after undergoing density-based separation, such as by centrifugation. The system 900 includes the first float 700. The system 900 is similar to the system 100 except that the first float 700 is disc-shaped. The first float 700 may be located at or above the uppermost layer of the density-separated suspension, thereby creating a component-float-air interface. The first float 700 has a density that is less than or equal to the density of any fraction of the suspension. The first float 700 creates a component-float-air interface to decrease the surface area of the component-air interface, thereby reducing or eliminating the introduction of air into the suspension 106 when a tube 102 is pressurized. When the tube 102 is de-pressurized and air is present, bubbles may form within the suspension 106. These bubbles can affect imaging, detection, enumeration, and retrieval of the target analyte located in the fraction 804. Removing or reducing the air that diffuses into the suspension may permit for more accurate imaging, detection, enumeration, and retrieval of the target analyte.

The first float 700 may also be used for quality control purposes or to trap a first target analyte located in the fraction 802. The second float 114 may be used to trap a second target analyte located in fraction 804. The first float 700, however, may be used to trap the first target analyte, such as lysed or fragmented pieces of the second target analyte or a different type of analyte, to test and determine whether the second target analyte is damaged. When the first target analyte is damaged, then it is highly likely that the second target analyte, after being trapped, may be damaged as well. Various properties or characteristics of the first target analyte may be altered when the second target analyte has been damaged. These alterations may have a significant effect on subsequent analysis or processing. When the first target analyte is undamaged, then it is likely that the second target analyte will be undamaged as well.

FIG. 9B shows an isometric view of a tube and multiple floats system 910 after undergoing density-based separation, such as by centrifugation. The system 910 includes the first float 710. The system 910 is similar to the system 900 except that the first float 710 is hourglass-shaped.

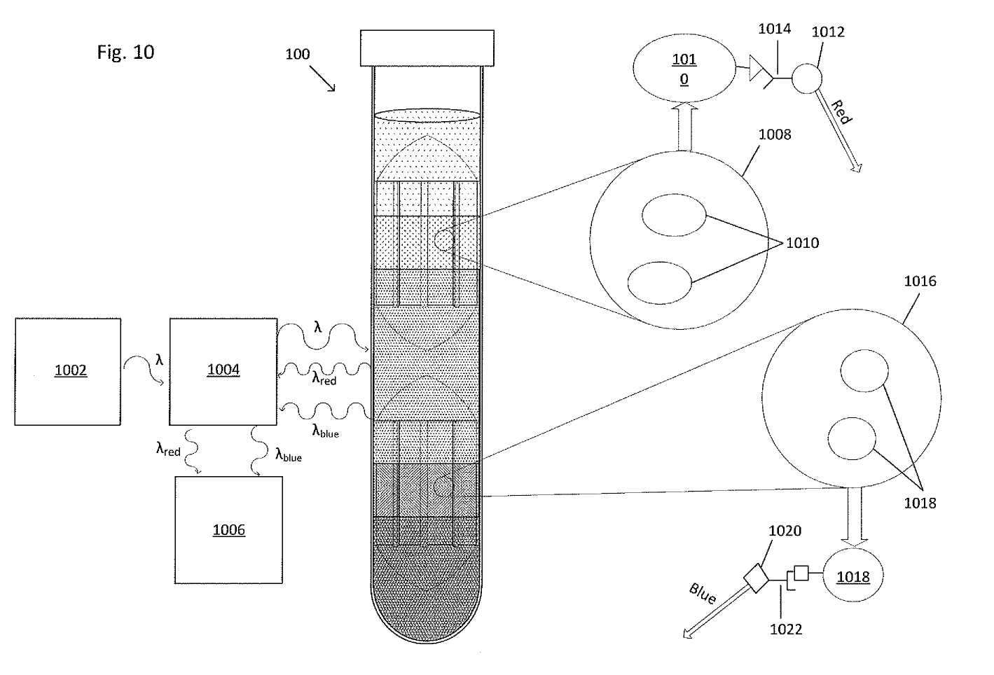

FIG. 10 shows an isometric view and magnified views of an imaging process. To image, an analysis area of a tube and multiple floats system 100, having undergone density-based separation, is illuminated with one or more channels or light from a light source 1002, having different wavelengths, such as red, blue, green, and violet or ultraviolet. The light, denoted by λ, is emitted by the light source 1002 and focused by and passed through the objective 1004 to the analysis area within the tube 102. The analysis area is a space between the floats and tube in which target analytes 1010 and 1018 may be retained or trapped. The different channels can excite different fluorescent probes 1012 and 1020 of the different target analytes 1010 and 1018 based on the channels' respective wavelengths, causing the fluorescent probes 1012 and 1020 to emit light at a particular wavelength. The fluorescent probes 1012 and 1020 can be bound to different ligands 1014 and 1022, such that the different ligands bind to the different target analytes 1010 and 1018. Alternatively, the same ligand and/or fluorescent probe may be used to label the different target analytes 1010 and 1018, when it desirable to do so. The light emitted by the excited fluorescent probes 1012 and 1020 on the target analytes 1010 and 1018 can be captured by the objective 1004 and transmitted to a detector 1006. The detector 1006 may be a charge-coupled device (“CCD”) for capturing image data, which may then be compiled into images, processed and analyzed by a computer or associated software or programs. The images formed from each of the channels can be overlaid when multiple fluorescent probes, having bound themselves to the target analyte, are excited and emit light. The light source 1002 and the objective 1004 may be separate pieces or may be one piece. The light source 1002 and the objective 1004 may be coaxial or may be located on different planes. The target analytes 1010 and 1018 may then be characterized, and the respective locations identified, based on the light emission(s) from the fluorescent probe(s) 1012 and 1020 on the target analytes 1010 and 1018.

The target analytes 1010 and 1018 may have a number of different types of surface protein molecules located on the surface. Each type of surface protein is a molecule, such an antigen, capable of attaching a particular ligand, such as an antibody. As a result, ligands can be used to classify the target particles and determine the specific type of target particles present in the suspension by conjugating ligands that attach to particular surface proteins with a particular fluorescent probe. For example, each type of fluorescent probe emits light in a narrow wavelength range of the electromagnetic spectrum called a “channel” when an appropriate stimulus, such as light with a shorter wavelength, is applied. A first type of fluorescent probe that emits light in the red channel can be attached to a first ligand that binds specifically to a first type of surface protein of a first target analyte; a second type of fluorescent probe that emits light in the blue channel can be attached to a second ligand that binds specifically to a second type of surface protein of a second target analyte. The channel color observed as a result of stimulating the target material identifies the type of surface protein, and because surface proteins can be unique to particular target particles, the channel color can also be used to identify the target particle. Examples of suitable fluorescent probes include, but are not limited to, commercially available dyes, such as quantum dots, fluorescein, FITC (“fluorescein isothiocyanate”), R-phycoerythrin (“PE”), Texas Red, allophycocyanin, Cy5, Cy7, cascade blue, DAPI (“4′,6-diamidino-2-phenylindole”) and TRITC (“tetramethylrhodamine isothiocyanate”), and combinations of dyes, such as CY5PE, CY7APC, and CY7PE.

The ligands may include a primary antibody that bind to biomarkers, the biomarkers include, but are not limited to, EpCAM, AMACR, Androgen receptor, CD146, CD227, CD235, CD24, CD30, CD44, CD45, CD56, CD81, CD105, CD324, CD325, MUC1, CEA, cMET, EGFR, Folate receptor, HER2, Mammaglobin, PSMA, or combinations thereof.

It should be noted that the target analyte need not be in one single focal plane between the tube and magnetizable float to be properly imaged. The target analyte may appear at any depth and at any focal plane between the tube and the magnetizable float.

It should be further noted that multiple floats, not being limited in number, may be used to separate any number of target analytes from a suspension and/or create a suspension-air-float interface. When, for example, a suspension has three different target analytes, it may be desirous to use three floats (all three of which can come into axial alignment with three different target analytes) or to use four floats (three of which can come into axial alignment with three different target analytes and the fourth to create an interface with the air and suspension); it may be desirous to use four or five floats with a suspension having four different target analytes; and so on.

The target analytes may be fixed, permeabilized, and labeled. The system is then analyzed to determine the location and characterization of at least one specific target analyte. The target analytes may then be isolated and analyzed using any appropriate analysis method or technique, though more specifically extracellular analysis and/or intracellular analysis including intracellular protein labeling, in situ hybridization (“ISH”—a tool for analyzing DNA and/or RNA, such as gene copy number changes), or branched DNA (“bDNA”—a tool for analyzing DNA and/or RNA, such as mRNA expression levels) analysis. These techniques require fixation, permeabilization, and isolation of the target analyte prior to analysis. Some of the intracellular proteins which may be labeled include, but are not limited to, cytokeratin (“CK”), actin, Arp2/3, coronin, dystrophin, FtsZ, myosin, spectrin, tubulin, collagen, cathepsin D, ALDH, PBGD, Akt1, Akt2, c-myc, caspases, survivin, p27^{kip}, FOXC2, BRAF, Phospho-Akt1 and 2, Phospho-Erk1/2, Erk1/2, P38 MAPK, Vimentin, ER, PgR, PI3K, pFAK, KRAS, ALKH1, Twist/, Snail1, ZEB1, Slug, Ki-67, M30, MAGEA3, phosphorylated receptor kinases, modified histories, chromatin-associated proteins, and MAGE. To fix, permeabilize, or label, fixing agents (such as formaldehyde, formalin, methanol, acetone, paraformaldehyde, or glutaraldehyde), detergents (such as saponin, polyoxyethylene, digitonin, octyl (3-glucoside, octyl β-thioglucoside, 1-S-octyl-β-D-thioglucopyranoside, polysorbate-20, CHAPS, CHAPSO, (1,1,3,3-Tetramethylbutyl)phenyl-polyethylene glycol or octylphenol ethylene oxide), or labeling agents (such as fluorescently-labeled antibodies, Pap stain, Giemsa stain, or hematoxylin and eosin stain) may be used.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise forms described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

I/We claim:

1. A system for separating suspended target materials, comprising:
a first float having a first density;
a second float having a second density; and,
a tube having an elongated sidewall of a first cross-section shape.

2. The system of claim 1, wherein the second float is denser than the first float.

3. The system of claim 2, wherein the first float is configured to trap a first target analyte and wherein the second float is configured to trap a second target analyte.

4. The system of claim 3, wherein the first target analyte is a fragmented or lysed portion of the second target analyte.

5. The system of claim 3, wherein the first target analyte is different from the second target analyte.

6. The system of claim 5, further comprising a first solution including a first fluorescent marker to label the first target analyte and to provide a fluorescent signal for identification and characterization; and, a second solution including a second fluorescent marker to label the second target analyte and to provide a fluorescent signal for identification and characterization.

7. The system of claim 2, wherein the first and second floats mate together.

8. The system of claim 7, wherein the first float comprises a concave bottom end cap and the second float comprises a protruding top end cap.

9. The system of claim 7, wherein the first float comprises a protruding bottom end cap and the second float comprises a concave top end cap.

10. The system of claim 2, wherein the first float creates a float-air interface to reduce or eliminate the introduction of air into the suspension.

11. The system of claim 10, wherein the first float is disc-shaped.

12. The system of claim 10, wherein the first float is hourglass-shaped.

13. The system of claim 1, further comprising at least one more float.

14. The system of claim 13, wherein no two floats have the same density.

15. The system of claim 2, wherein the first and second floats moved dependently on one another, such that a consistent distance between the first and second floats is maintained during centrifugation.

16. The system of claim 15, wherein the distance is maintained mechanically.

17. The system of claim 15, wherein the bottom end of the first float and the top end of the second float include magnets to repel or attract each other so as to maintain a consistent distance between the first and second floats.

18. The system of claim 2, wherein the first and second floats are capable of trapping a target analyte or suspension material between the first and second floats.

19. The system of claim 18, wherein the first float comprises a substantially planar bottom end cap and the second float comprises a substantially planar top end cap.

20. The system of claim 18, wherein the bottom end of the first float and the top end of the second float include magnets to repel or attract each other so as to trap the target analyte or suspension material between the first and second floats.
